(19) United States
(12) Patent Application Publication
(10) Pub. No.: US 2018/0363230 A1
(43) Pub. Date: Dec. 20, 2018

(54) WALL-MOUNTED WASHING MACHINE

(71) Applicant: Dongbu Daewoo Electronics Corporation, Seoul (KR)

(72) Inventor: Sang Ki HAN, Seoul (KR)

(21) Appl. No.: 15/865,053

(22) Filed: Jan. 8, 2018

(30) Foreign Application Priority Data
Jun. 15, 2017 (KR) 10-2017-0075922

(51) Int. Cl. D06F 58/02; D06F 58/26; D06F 58/24; F26B 11/02

(52) U.S. Cl. CPC D06F 58/02; F26B 11/028; D06F 58/24; D06F 58/26

(57) ABSTRACT

A drying device in a wall-mounted washing machine includes a tub and a drying device. The drying device includes a fan coupled to the tub, a hot air supply duct coupled to the fan and configured to guide air from the fan into the tub, a drying heater disposed inside the hot air supply duct and configured to heat air introduced into the hot air supply duct, and a hot air discharge duct coupled to the tub and configured to guide air flowing from the tub toward the fan as well as dehumidify the air. The hot air discharge duct includes a first duct formation member disposed on an outer circumferential surface of the tub and a second duct formation member fused to the first duct formation member. The first duct formation member and the second duct formation member include fused surfaces formed on the same plane.

### CROSS-REFERENCE TO RELATED APPLICATION

This application is based on and claims priority from Korean Patent Application No. 10-2017-0075922, filed on Jun. 15, 2017, the disclosure of which is incorporated herein in its entirety by reference for all purposes.

### TECHNICAL FIELD

The present disclosure relates to wall-mounted washing machines, and more particularly, to drying mechanisms in wall-mounted washing machines.

### BACKGROUND

In general, a wall-mounted washing machine can be installed and used on a wall, and typically has a compact design, making it advantageous to use in a small room space.

A typical wall-mounted washing machine includes a cabinet, a tub movably disposed within the cabinet and configured to store washing water, a drum rotatably installed in the tub and configured to accommodate washing objects, a drive unit configured to supply power to the drum, a water supply device configured to supply washing water into the tub, and a water drain device configured to drain the washing water from the tub to someplace outside of the cabinet.

During a washing operation, washing water is supplied into the tub and in the drum by the operation of the water supply device, and the drum is rotated by the drive unit. At the end of washing, washing water contained in the tub and the drum is drained to the outside of the cabinet through the water drain device by the operation of the water drain device.

In recent years, there has been a trend that a wall-mounted washing machine is integrated with a built-in drying device for drying washed objects. Typically, such a drying device is configured to dry washing objects by drawing external air into the tub. The drying efficiency of such a built-in drying device depends on the configuration of hot air circulation in the washing machine.

Typically in such a drying device, a duct member through which an air is drawn or discharged is manufactured by combining a first duct formation member and a second duct formation member. In some cases, the duct member is formed in a curvilinear shape, which makes it difficult to combine the second duct formation member with the first duct formation member.

### SUMMARY

Embodiments of the present disclosure provide a wall-mounted washing machine including a built-in drying device that can be manufactured easily.

In accordance with a first embodiment of the present disclosure, there is provide a wall-mounted washing machine, including: a tub; and a drying device. The drying device includes a fan coupled to the tub and configured to propel air; a hot air supply duct coupled to the fan and configured to guide air flowing from the fan to the tub; a drying heater disposed inside the hot air supply duct and configured to heat air inside the hot air supply duct; and a hot air discharge duct coupled to the tub and configured to guide air exiting from the tub toward the fan and dry air exiting from the tub. The hot air discharge duct includes a first duct formation member disposed on an outer circumferential surface of the tub and a second duct formation member fused to the first duct formation member. The first duct formation member and the second duct formation member include fused surfaces formed on a same plane.

The second duct formation member may include an end portion which includes a flow path expanding portion protruding radially outward to expand an air flow path for air exiting from the tub.

The first duct formation member may include a lower portion and an upper end portion. The lower portion of the first duct formation member may have a shape corresponding to an external shape of the tub, and the upper end portion of the first duct formation member may be disposed on the same plane as a lower end portion of the second duct formation member.

A lower portion of the first duct formation member may have a curved surface shape.

The drying device may further include a condensing water introduction port disposed in the hot air discharge duct. The condensing water introduction port may be configured to receive condensing water supplied to the hot air discharge duct. At least one curved portion may be formed on one surface of the hot air discharge duct opposite to the condensing water introduction port.

One surface of the hot air discharge duct may be curved to bulge toward the condensing water introduction port.

A longitudinal cross section of the condensing water introduction port may have an area that grows larger from a central portion of the condensing water introduction port toward opposite end portions of the condensing water introduction port.

The fan, the hot air supply duct, the tub and the hot air discharge duct may be configured to form a closed air circulation path.

The washing machine may further include: a rear panel configured to support the tub to be affixed to a wall surface; a drum rotatably installed inside the tub and configured to accommodate washing objects; and a tub front panel coupled to a front surface of the tub.

The drying device may be configured to communicate air with a front upper portion of the tub front panel and a rear lower portion of the tub.

A first end portion of the hot air supply duct that is proximate to the tub front panel may be coupled to the front upper portion of the tub front panel. A second end portion of the hot air discharge duct that is proximate to the tub may be coupled to the rear lower portion of the tub.

The drying heater may be configured to, when the fan is operational, heat air passing through the hot air supply duct, wherein further air exiting from the hot air supply duct is introduced into the tub through the tub front panel, wherein the condensing water is operable to cool and dehumidify air exiting from the tub, and wherein air exiting from the hot air discharge duct is introduced into the fan.

The rear panel may include at least one vent hole for air to flow through.

A rear surface of the rear panel may include a plurality of ribs, and end portions of the plurality of ribs may include cut away portions that form air circulation grooves.

The wall-mounted washing machine according to one embodiment of the present disclosure includes an air duct composed of two parts fused together, which are easy to manufacture and assemble. Therefore, the manufacturing efficiency of the drying device is advantageously enhanced while the drying efficiency of the drying device is preserved.

### BRIEF DESCRIPTION OF THE DRAWINGS

FIG. 1 is a front perspective view showing the configuration of an exemplary wall-mounted washing machine according to one embodiment of the present disclosure.

FIG. 2 is a rear perspective view showing the configuration of the exemplary wall-mounted washing machine according to one embodiment of the present disclosure.

FIG. 3 is an exploded perspective view showing the exemplary wall-mounted washing machine according to one embodiment of the present disclosure.

FIG. 4 is a rear view showing the exemplary wall-mounted washing machine according to one embodiment of the present disclosure.

FIG. 5 is a sectional view showing a state in which the exemplary wall-mounted washing machine is installed on a wall surface according to one embodiment of the present disclosure.

FIG. 6 is a perspective view showing the configuration of an exemplary rear panel and an exemplary tub according to one embodiment of the present disclosure.

FIG. 7A is a perspective view showing the configuration of the exemplary rear panel and the exemplary tub according to one embodiment of the present disclosure, which are viewed at another angle, and FIG. 7B is a perspective view showing a state in which a second duct formation member of a hot air discharge duct of a drying device shown in FIG. 7A is detached.

FIG. 8 is a front view showing the configuration of the exemplary rear panel and the exemplary tub shown in FIG. 6.

FIG. 9 is a plan view showing the configuration of the exemplary rear panel and the exemplary tub in FIG. 6.

FIG. 10 is a right side view showing the configuration of the exemplary rear panel and the exemplary tub in FIG. 6.

FIG. 11 is a left side view showing the configuration of the exemplary rear panel and the exemplary tub in FIG. 6.

FIG. 12 is a perspective view showing the configuration of an exemplary drying device according to one embodiment of the present disclosure.

FIG. 13 is a front view showing the configuration of the exemplary drying device according to one embodiment of the present disclosure.

FIG. 14 is a sectional view taken along line XIV-XIV in FIG. 12.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily illustrated to scale. Relative sizes and proportions of parts in the drawings may be exaggerated or reduced in size, and any predetermined size is merely exemplary and not limiting. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, may include modification of form due to manufacturing.

Preferred embodiments of the present disclosure are described in detail with reference to the accompanying drawings.

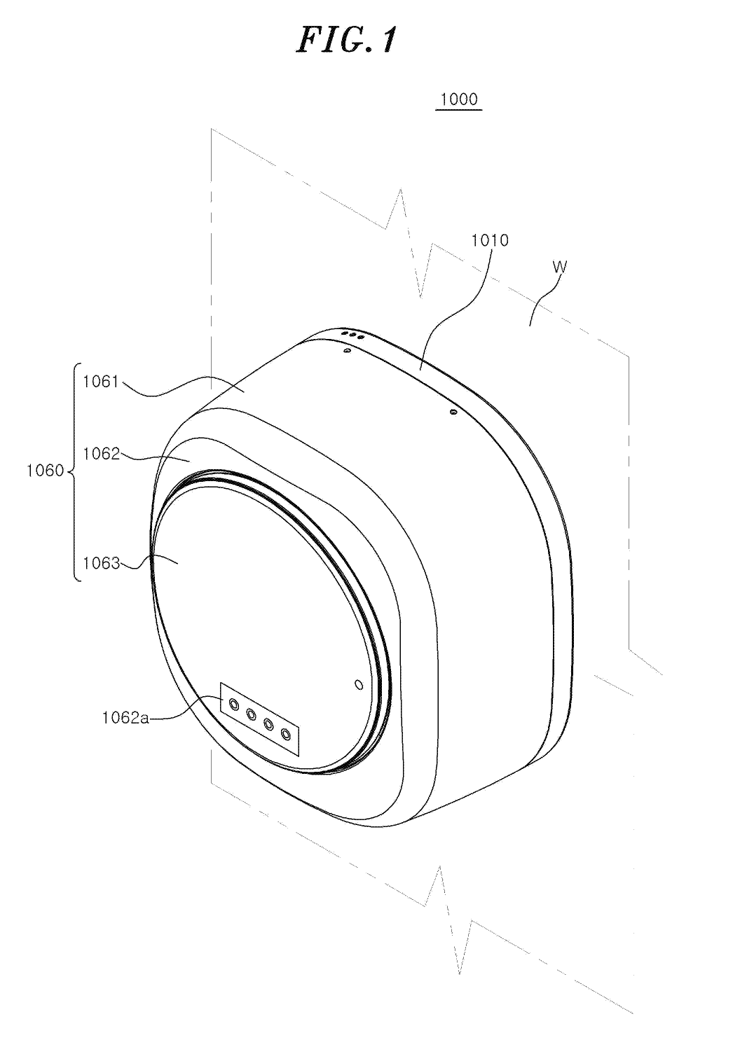

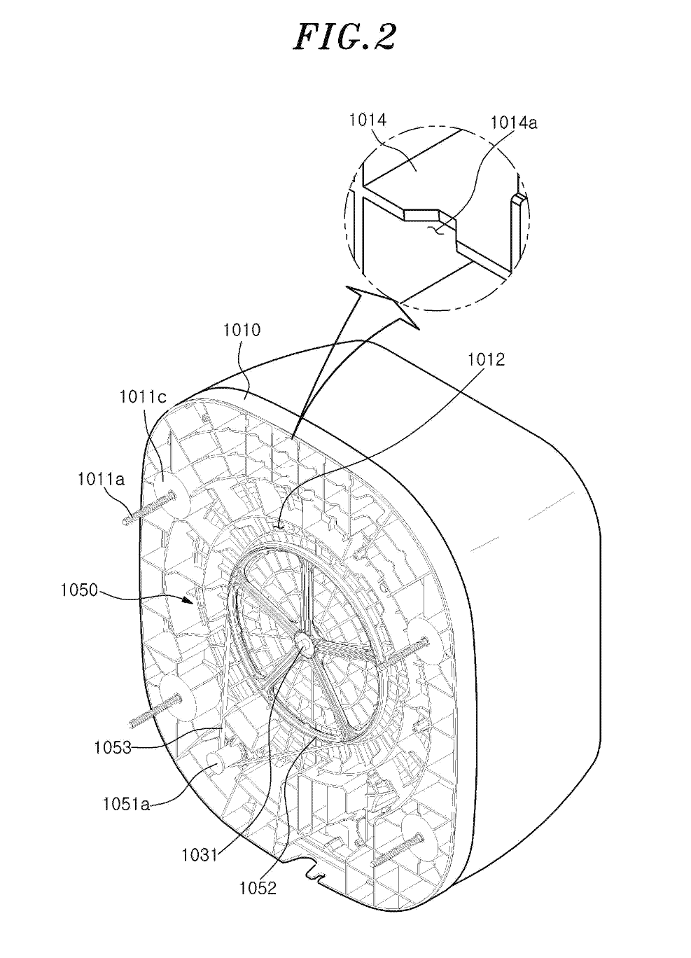

FIG. 1 is a front perspective view showing the configuration of an exemplary wall-mounted washing machine according to one embodiment of the present disclosure. FIG. 2 is a rear perspective view showing the configuration of the exemplary wall-mounted washing machine in FIG. 1.

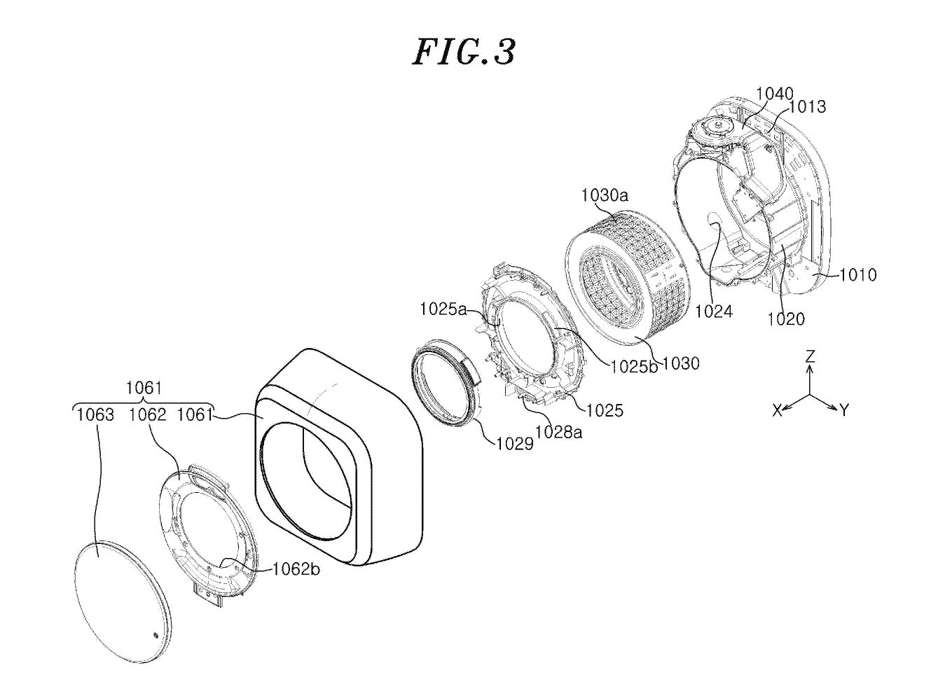

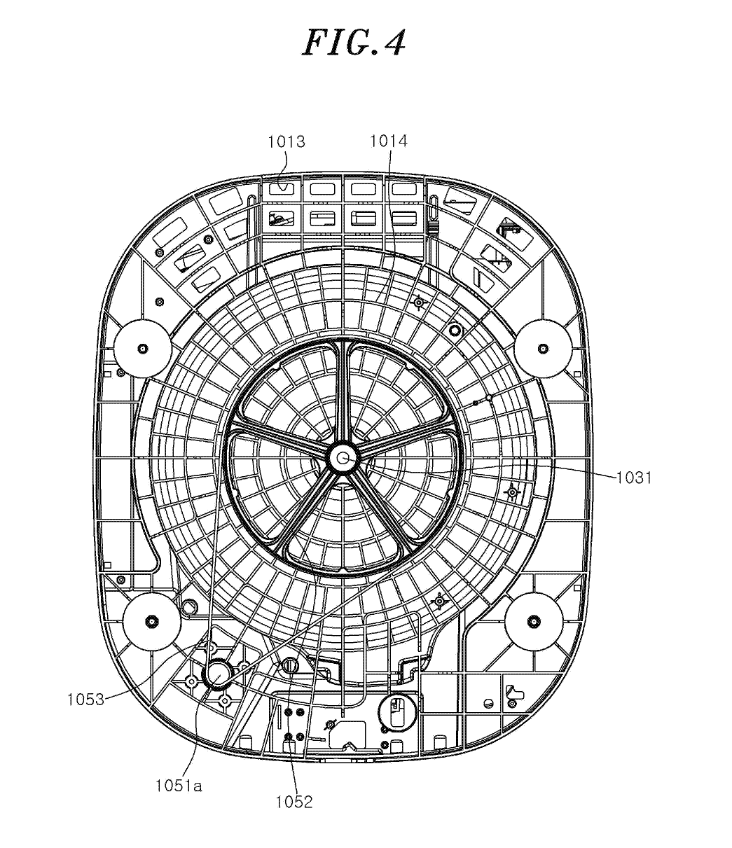

Referring to FIGS. 1 and 2, the wall-mounted washing machine 1000 according to one embodiment of the present disclosure is a washing machine configured to be hung on, affixed to, or otherwise installed on a wall surface W. The wall-mounted washing machine 1000 may include a housing 1060 forming an outer shell, and a rear panel 1010 coupled to a rear surface of the housing 1060 and attached to the wall surface W. The housing 1060 may include a side cover 1061 forming a side surface of the wall-mounted washing machine 1000, a front cover 1062 forming a front surface of the wall-mounted washing machine 1000, and a door 1063 rotatably coupled to the front cover 1062. A user may open the door 1063 to load or unload washing objects. Hereinafter, the detailed configuration of the wall-mounted washing machine 1000 according to one embodiment of the present disclosure is described with reference to FIGS. 3 to 14.

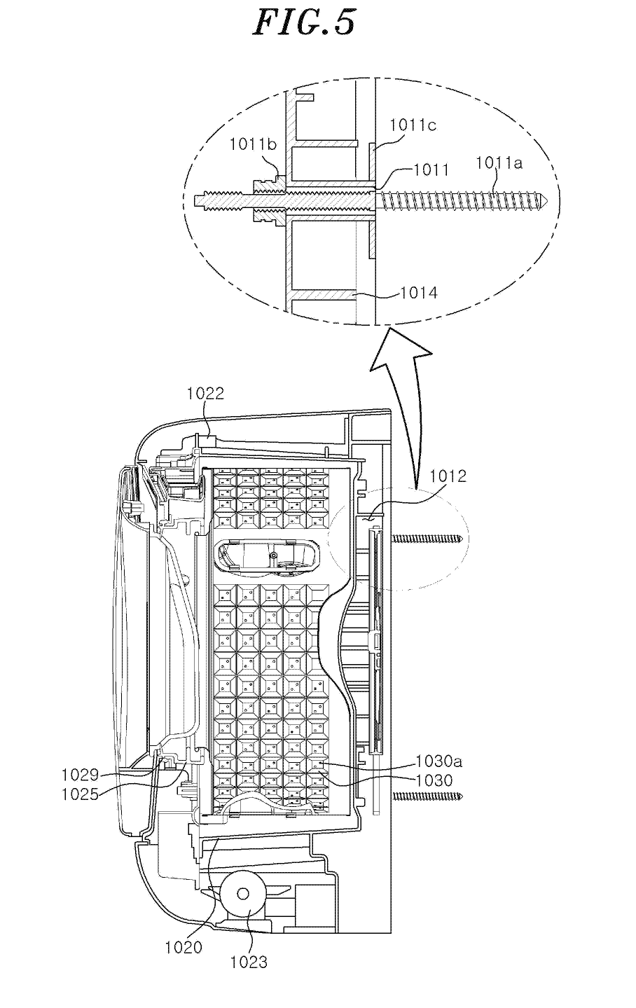

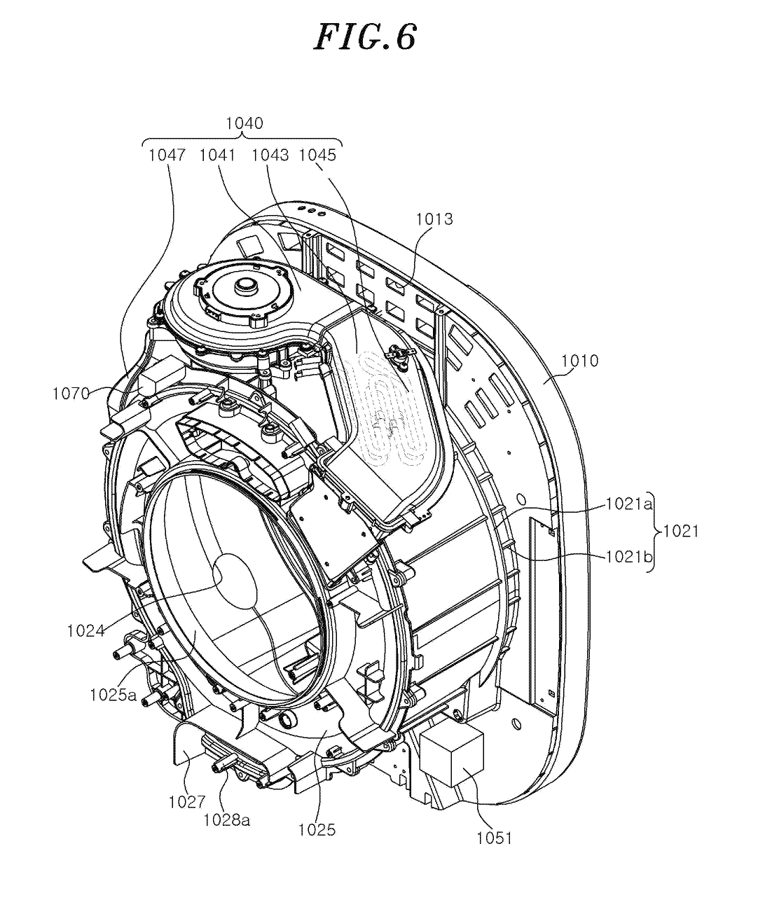

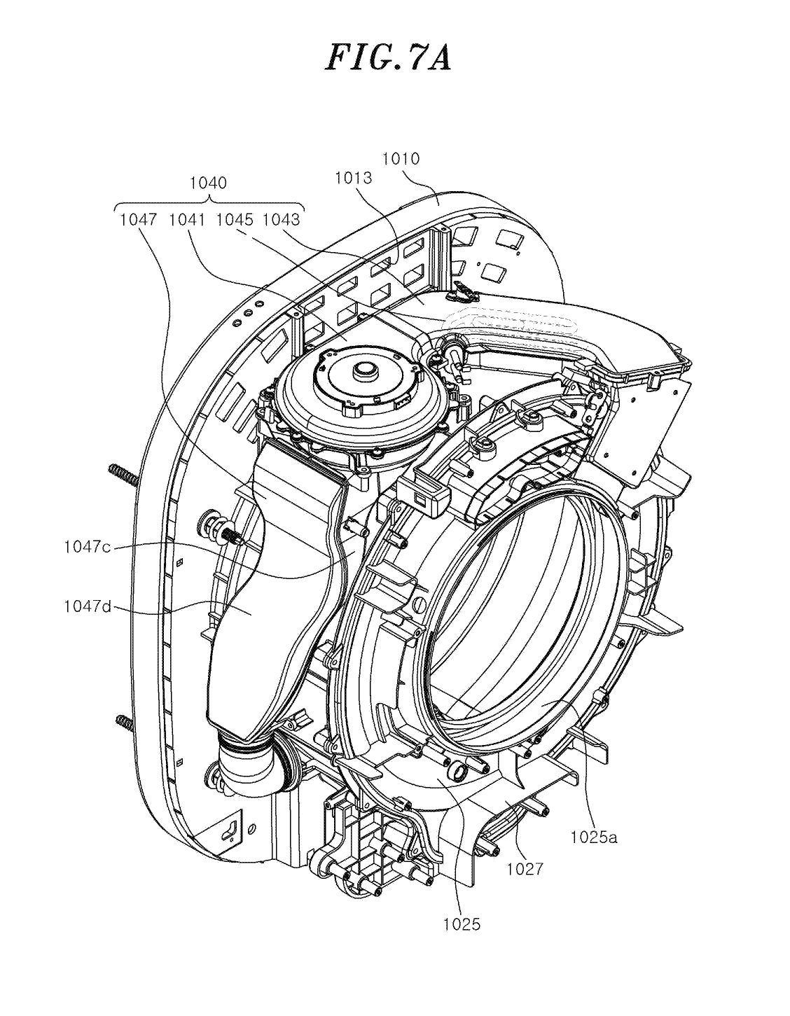

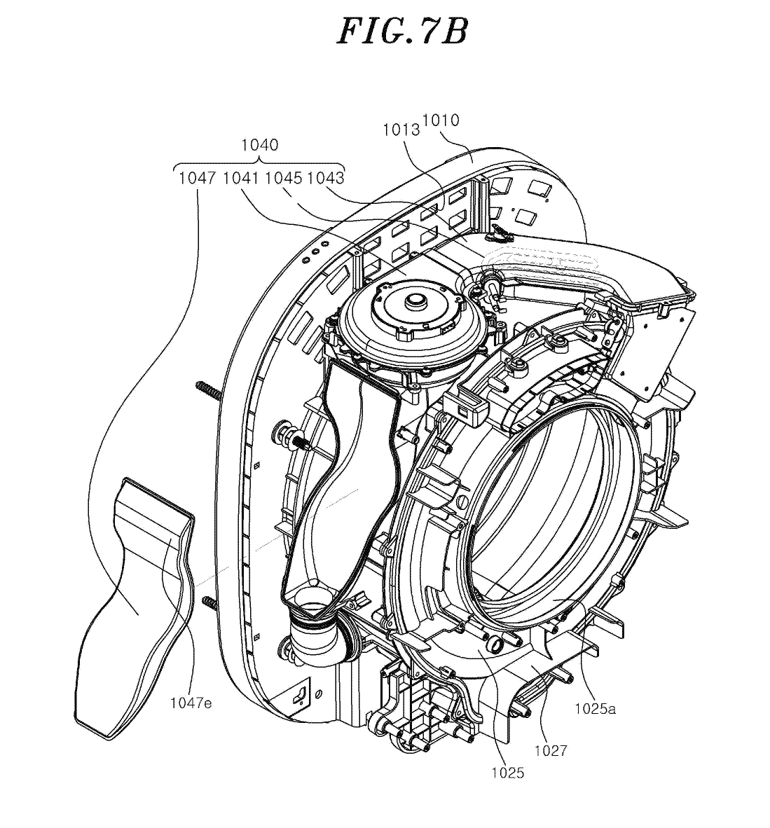

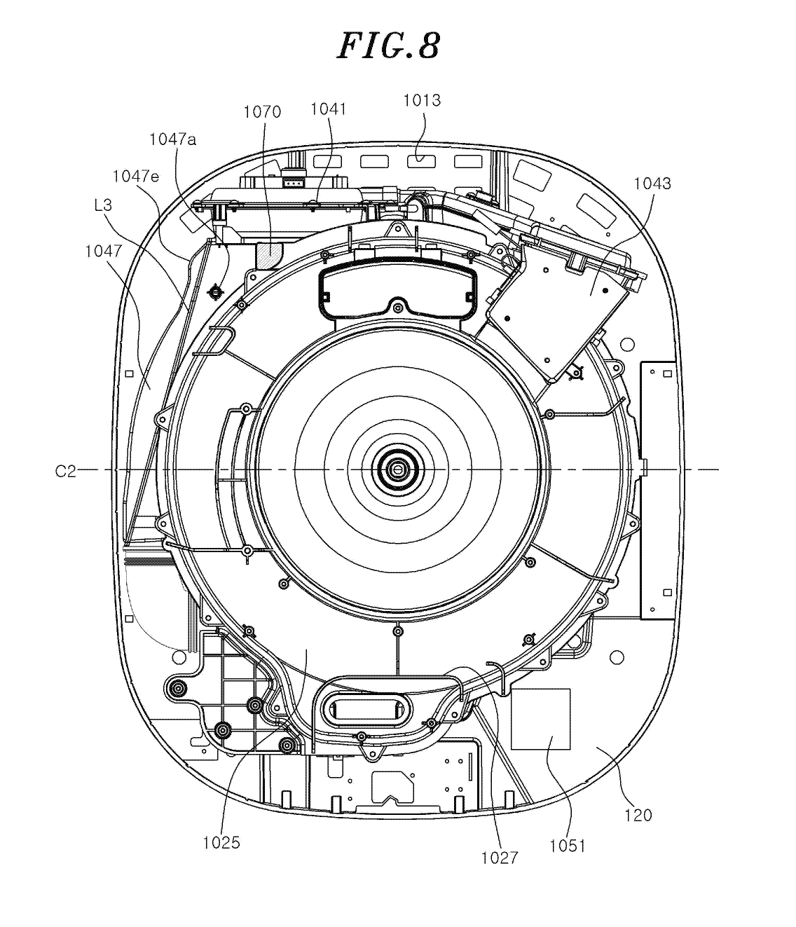

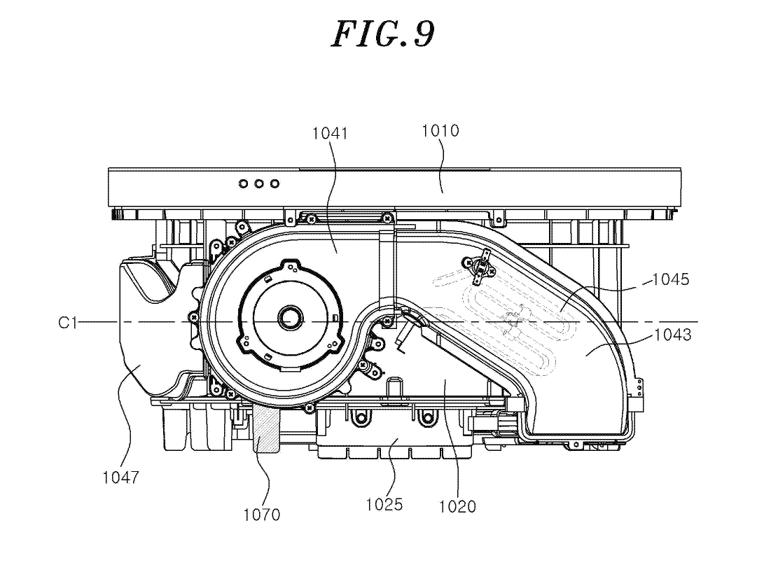

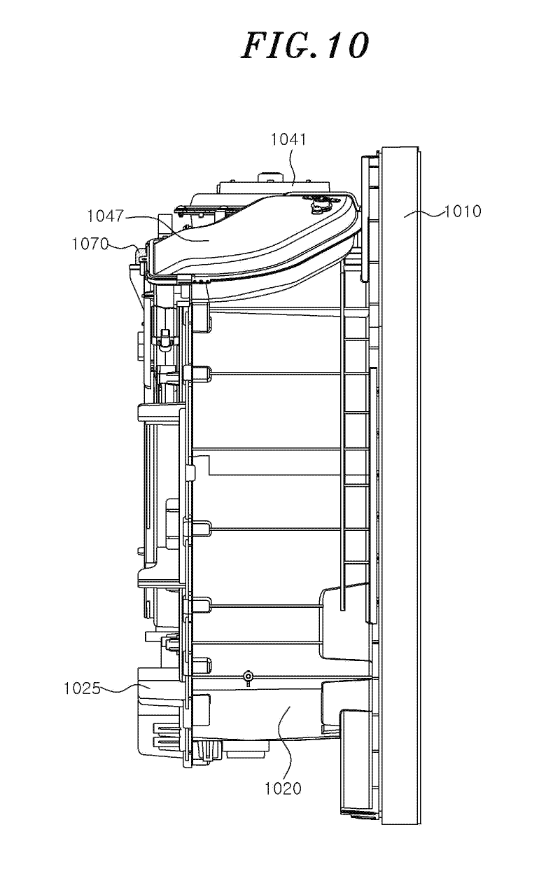

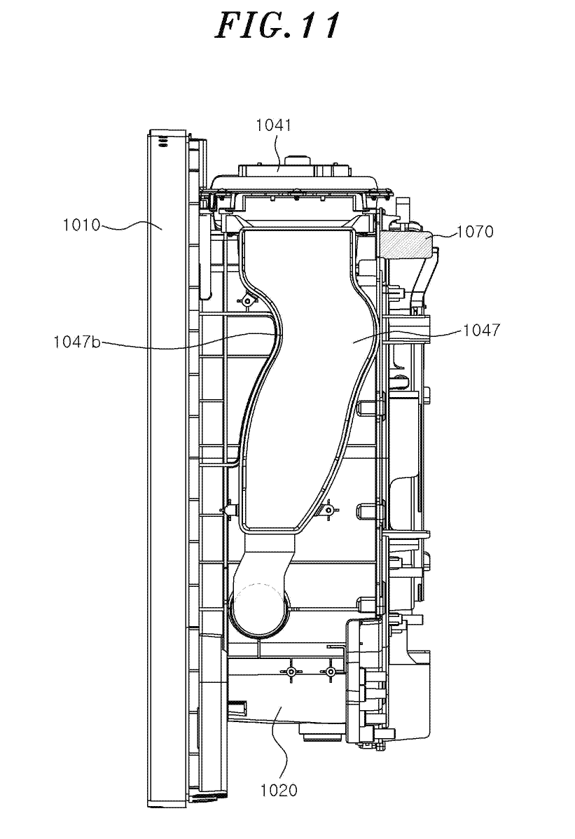

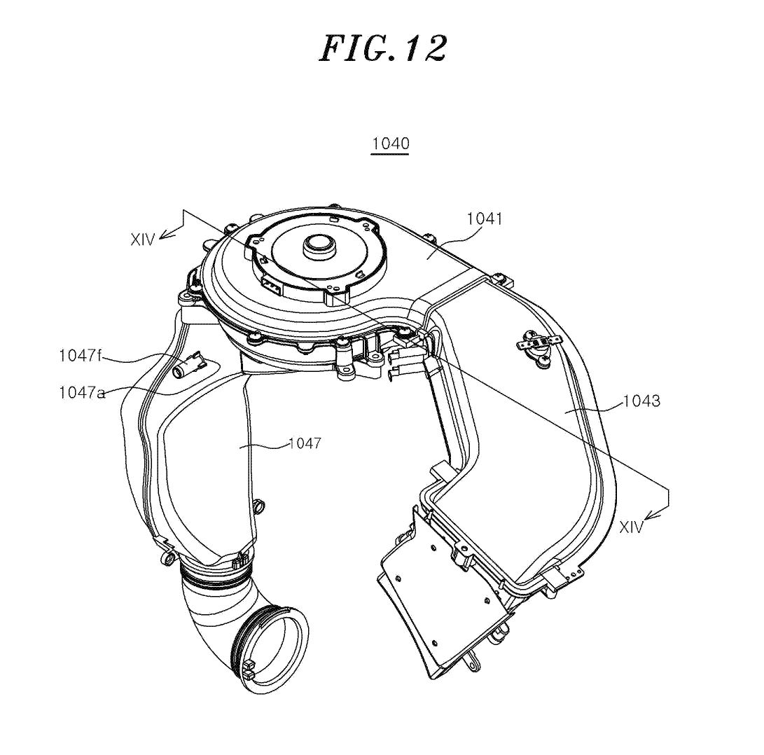

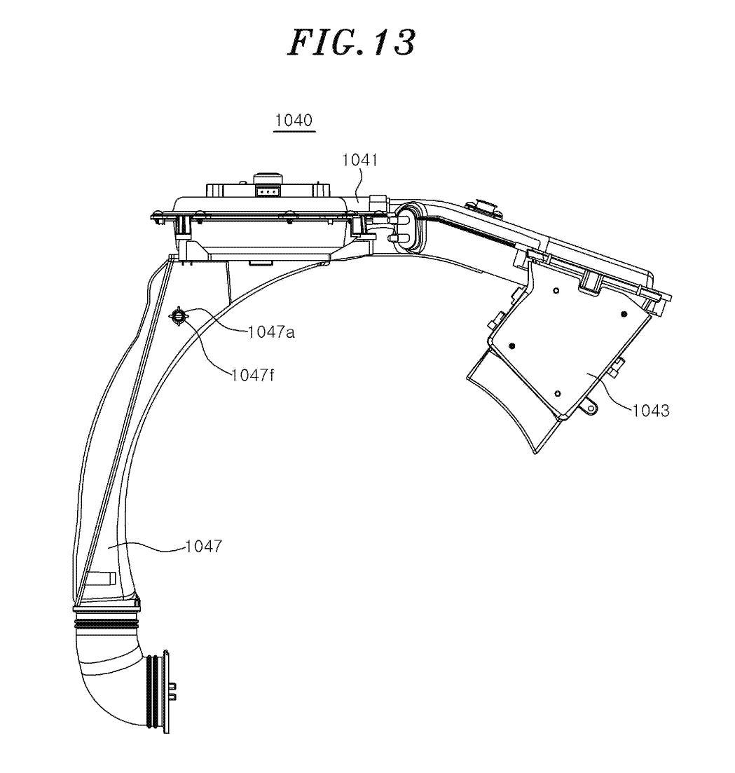

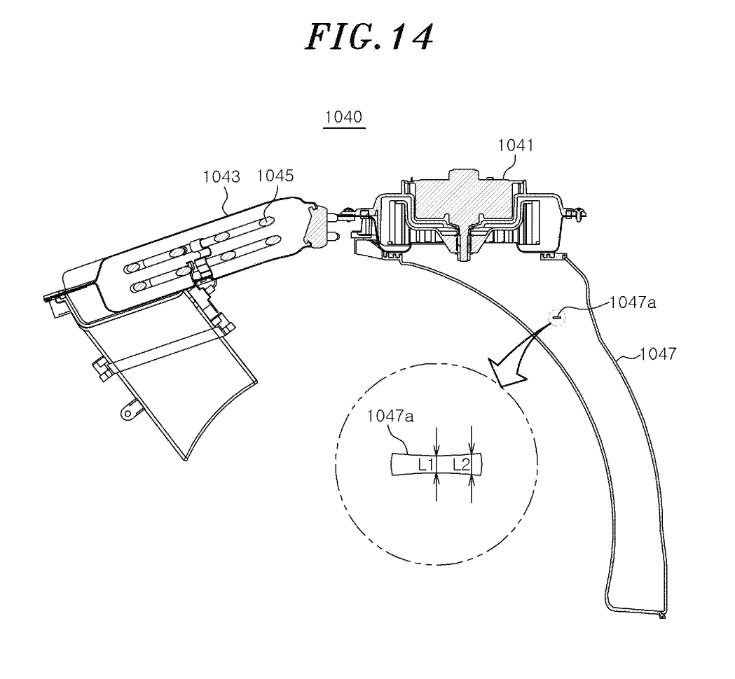

FIG. 3 is an exploded perspective view showing the exemplary wall-mounted washing machine according to one embodiment of the present disclosure. FIG. 4 is a rear view showing the exemplary wall-mounted washing machine according to one embodiment of the present disclosure. FIG. 5 is a sectional view showing a state in which the exemplary wall-mounted washing machine is installed on a wall surface according to one embodiment of the present disclosure. Fig. is a perspective view showing the configuration of an exemplary rear panel and an exemplary tub according to one embodiment of the present disclosure. FIG. 7A is a perspective view showing the configuration of the exemplary rear panel and the exemplary tub according to one embodiment of the present disclosure, which are viewed at another angle, and FIG. 7B is a perspective view showing a state in which a second duct formation member of a hot air discharge duct of a drying device shown in FIG. 7A is detached. FIG. 8 is a front view showing the configuration of the exemplary rear panel and the exemplary tub shown in FIG. 6. FIG. 9 is a plan view showing the configuration of the exemplary rear panel and the exemplary tub in FIG. 6. FIG. 10 is a right side view showing the configuration of the exemplary rear panel and the exemplary tub in FIG. 6. FIG. 11 is a left side view showing the configuration of the exemplary rear panel and the exemplary tub in FIG. 6. FIG. 12 is a perspective view showing the configuration of an exemplary drying device according to one embodiment of the present disclosure. FIG. 13 is a front view showing the configuration of the exemplary drying device according to one embodiment of the present disclosure. FIG. 14 is a sectional view taken along line XIV-XIV in FIG. 12.

Referring to FIGS. 3 to 14, the wall-mounted washing machine 1000 may include a rear panel 1010 that can be attached to a wall surface, a tub 1020 configured to store washing water and supported by the rear panel 1010, a drum 1030 rotatably installed inside the tub 1020 and configured to accommodate washing objects, a drying device 1040 coupled to an outer surface of the tub 1020 and configured to dry the washing objects, a drive unit 1050 configured to supply power for rotating the drum 1030, and a housing 1060 coupled to the rear panel 1010 and configured to form an outer shell of the wall-mounted washing machine 1000.

The rear panel 1010 can be affixed to the wall surface W. For example, the rear panel 1010 may be hung on the wall surface W by fastening members 1011a. To this end, through-holes 1011 may be formed in the rear panel 1010 for the fastening members 1011a to pass through.

An exemplary method of hanging the rear panel 1010 on the wall surface W is as follows. A user first installs the fastening members 1011a on the wall surface W and fits shock-absorbing members 1011c to the fastening members 1011a, which are used for reducing shock and vibration produced during operations. Thereafter, the user hangs the rear panel 1010 on the wall surface W. The fastening members 1011a are inserted into the through-holes 1011 of the rear panel 1010. Subsequently, nut members 1011b are coupled to the fastening members 1011a protruding forward from the rear panel 1010 through the through-holes 1011. As a result, the rear panel 1010 can be hung on the wall surface W.

A mounting groove portion 1012 may be formed on the rear surface of the rear panel 1010 so that a space is formed between the rear panel 1010 and the wall surface W. The mounting groove portion 1012 provides a space between the rear panel 1010 and the wall surface W for accommodating the drive unit 1050. During manufacturing, the mounting groove portion 1012 may be formed by depressing the rear surface of the rear panel 1010 by a predetermined depth.

At least one vent hole 1013 may be formed in the rear panel 1010. For example, a plurality of vent holes 1013 penetrating the rear panel 1010 may be formed in the upper portion of the rear panel 1010. The vent holes 1013 allow air existing between the rear panel 1010 and the housing 1060 to be discharged to the outside, thereby preventing the air inside the wall-mounted washing machine 1000 from being heated. In the drawings, there is shown only a configuration in which a plurality of vent holes 1013 having a substantially rectangular shape are arranged in the upper portion of the rear panel 1010. However, the present disclosure is not limited thereto. The positions and shapes of the vent holes may vary in different embodiments, for example to improve discharge efficiency of the air.

A plurality of ribs 1014 may be disposed on the rear surface of the rear panel 1010. The ribs 1014 may protrude from the rear surface of the rear panel 1010, which can enhance the rigidity of the rear panel 1010. In this case, the end portions of the ribs 1014 may be partially cut away to form air circulation grooves 1014a. Due to the air circulation grooves 1014a, air passing through the vent holes 1013 may be discharged to the outside.

The tub 1020 may be disposed on the front side of the rear panel 1010. During manufacturing, the tub 1020 may be substantially simultaneously injection-molded with the rear panel 1010 and may be integrally formed with the rear panel 1010. Alternatively, the tub 1020 may be manufactured as a separate member and then coupled to the rear panel 1010.

A water supply device 1022 and a water drain device 1023 may be coupled to the tub 1020. For example, the water supply device 1022 may be coupled to the upper portion of the tub 1020, and the water drain device 1023 may be coupled to the lower portion of the tub 1020. However, the coupling mechanisms of the water supply device 1022 and the water drain device 1023 may be replaced by other various mechanisms well-known in the related art.

The water supply device 1022 may be coupled to an external water supply source. For instance, once a user interacts with the operation unit 1062a to start a washing process, the water supply device 1022 may supply washing water into the tub 1020. The washing water supplied to the tub 1020 may enter the drum 1030 via washing water introduction holes 1030a disposed on the outer surface of the drum 1030.

When the washing work is completed, the washing water may be drained to the outside via the water drain device 1023 installed under the tub 1020.

The drum 1030 may be rotatably coupled to the inside of the tub 1020. For example, a driving shaft 1031 may be coupled to the drum 1030. The driving shaft 1031 may be coupled to the drive unit 1050 disposed on the rear surface of the rear panel 1010 so that the driving shaft 1031 can receive power from the drive unit 1050.

The drive unit 1050 may be coupled to the rear surface of the rear panel 1010 to rotate the drum 1030. In this regard, the drive unit 1050 may be coupled to the mounting groove portion 1012 of the rear panel 1010. The mounting groove portion 1012 may be an area depressed by a predetermined depth from the rear surface of the rear panel 1010.

For example, the drive unit 1050 may include a motor 1051 having a rotating shaft 1051a and configured to supply power, a driving wheel 1052 coupled to the driving shaft 1031, and a belt 1053 coupled to the rotating shaft 1051a and the driving wheel 1052 to transmit power from the motor 1051 to the driving wheel 1052. Thus, when the motor 1051 rotates, the rotating shaft 1051a of the motor 1051 may rotate the belt 1053, whereby the driving wheel 1052 may be rotated and drive the rotation of the drum 1030.

Washing objects may be accommodated inside the drum 1030. One or more washing water introduction holes 1030a may be formed on the outer surface of the drum 1030. Thus, the washing water supplied to the tub 1020 may be introduced into the drum 1030 via the washing water introduction holes 1030a to wash the washing objects.

Reinforcing ribs 1021 may be disposed in the rear portion of the tub 1020 where the tub 1020 and the rear panel 1010 make contact with each other. The terms related to directions referred hereinafter are defined as follows. The term “front” may refer to the direction extending from the rear panel 1010 toward the tub 1020 on the basis of FIG. 3, namely the positive X-axis direction. The term “rear” may refer to the direction extending from the tub 1020 toward the rear panel 1010 on the basis of FIG. 3, namely the negative X-axis direction.

The reinforcing ribs 1021 may be formed along the outer circumferential surface of the rear portion of the tub 1020 to protrude radially outward. The reinforcing ribs 1021 may include first reinforcing ribs 1021a extending in the circumferential direction of the tub 1020 and second reinforcing ribs 1021b configured to couple the rear surfaces of the first reinforcing ribs 1021a and the front surface of the rear panel 1010. In this regard, the second reinforcing ribs 1021b may be disposed on the outer circumferential surface of the tub 1020 and are spaced apart from one another in the circumferential direction. Some of the second reinforcing ribs 1021b may extend toward the front side of the tub 1020.

The reinforcing ribs 1021 can distribute the potential stress imposed on the portion where the tub 1020 and the rear panel 1010 couple to each other. This can prevent damage of the tub 1020 or accidental separation of the tub 1020 from the rear panel 1010.

A tub front panel 1025 may be coupled to the front side of the tub 1020. The tub front panel 1025 may be coupled to the tub 1020 to form an internal space in which the drum 1030 is disposed. A detour rib 1027 may be disposed in the lower portion of the tub front panel 1025. The detour rib 1027 may protrude frontward from the front surface of the tub front panel 1025. The transverse opposite end portions of the detour rib 1027 may be bent downward and thus have curved surfaces. As used herein, the term “transverse” may refer to the left-right direction when the wall-mounted washing machine 1000 is viewed from the front side, namely the Y-axis direction on the basis of FIG. 3.

A hot water heater power supply unit 1028a for supplying electric power to a hot water heater 1028 may be disposed under the detour rib 1027. Thus, the detour rib 1027 may prevent the washing water flowing out from the interior of the wall-mounted washing machine 1000 from contacting the hot water heater power supply unit 1028a. In addition, an operation unit 1062a coupled to the housing 1060 to be described later may be disposed under the detour rib 1027. The detour rib 1027 may prevent the washing water from entering the operation unit 1062a.

An opening 1025a may be formed in the tub front panel 1025. A gasket 1029 for sealing may be coupled to the opening 1025a of the tub front panel 1025. In this case, the edge portion that forms the opening 1025a of the tub front panel 1025 may have a step-like shape to increase the coupling strength with the gasket 1029. The gasket 1029 may seal a gap between the housing 1060 and the tub 1020 and may prevent foreign materials from entering the space between the tub front panel 1025 and the drum 1030. The gasket 1029 is fitted to the opening 1025a of the tub front panel 1025. At least part of the outer circumferential surface of the gasket 1029 may make selective contact with the door 1063 (to be described below), and the remaining part of the outer circumferential surface of the gasket 1029 may make close contact with the opening 1025a. For example, the gasket 1029 may have a diameter corresponding to the diameter of the opening 1025a of the tub front panel 1025. The gasket 1029 may have a ring shape with the central portion thereof opened and may be made of a rubber material.

A hot air introduction port 1025b, into which hot air discharged from a hot air supply duct 1043 of the drying device 1040 (to be described below) is introduced, may be disposed in the front upper portion of the tub front panel 1025. The hot air introduced through the hot air introduction port 1025b may move toward the drum 1030 disposed inside the tub 1020. A drying process using hot air is described in greater detail below.

The drying device 1040 for drying the washing objects may be disposed on the outer surface of the tub 1020. The drying device 1040 operates to dry the objects loaded in the drum (e.g., washing objects) by supplying hot air into the tub 1020. The drying device 1040 may communicate air with the front upper portion of the tub front panel 1025 and the rear lower portion of the tub 1020.

As one example, the drying device 1040 may include a fan 1041 coupled to the upper portion of the tub 1020 and configured to propel or blow air, a hot air supply duct 1043 coupled to the fan 1041 and configured to supply air from the fan 1041 into the tub 1020 through the hot air introduction port 1025b that is formed in the tub front panel 1025, a drying heater 1045 disposed inside the hot air supply duct 1043 and configured to heat the air introduced into the hot air supply duct 1043, and a hot air discharge duct 1047 coupled to the tub 1020 and configured to guide the air exiting from the tub 1020 toward the fan 1041 and to cool and dehumidify the air passing through the tub 1020.

In the drying device 1040 provided in the wall-mounted washing machine 1000 according to one embodiment of the present disclosure, the fan 1041, the hot air supply duct 1043, the tub 1020 and the hot air discharge duct 1047 may form a closed air circulation path. In other words, the drying device 1040 may perform a drying process by circulating air inside the wall-mounted washing machine 1000. That is, when the fan 1041 of the drying device 1040 is operational, air is heated and becomes hot dry air by the drying heater 1045 while it passes through the hot air supply duct 1043. The hot dry air may be introduced into the tub 1020 to dry the washing objects accommodated in the drum 1030. At this time, air in the tub 1020 absorbs moisture from, and thereby dries, the washing objects. Air having high moisture content is blown from the tub toward the hot air discharge duct 1047 by the fan 1041 and is discharged to the outside.

The hot air discharge duct 1047 provides a path through which the air discharged from the tub 1020 moves. The hot air discharge duct 1047 may be disposed on the outer surface of the tub 1020. For example, the hot air discharge duct 1047 may include a first duct formation member 1047c disposed on the outer surface of the tub 1020 and a second duct formation member 1047d coupled to (e.g., fused to) the first duct formation member 1047c and configured to form a flow path for air to pass through the tub 1020. That is to say, the second duct formation member 1047d may be coupled to the open upper portion of the first duct formation member 1047c and may form an air flow path. In this regard, the upper portion and the lower portion of the first duct formation member 1047c refer to the radial outer side and the radial inner side of the first duct formation member 1047c in the respective drawings. The upper portion and the lower portion of the second duct formation member 1047d refer to the radial outer side and the radial inner side of the second duct formation member 1047d. The first duct formation member 1047c and the second duct formation member 1047d may be fused to each other. In other words, the first duct formation member 1047c and the second duct formation member 1047d may be coupled to each other by applying heat to the upper end portion of the first duct formation member 1047c and the lower end portion of the second duct formation member 1047d.

In this case, the fused portions of the first duct formation member 1047c and the second duct formation member 1047d may be disposed on the same plane. In other words, the upper end portion of the first duct formation member 1047c and the lower end portion of the second duct formation member 1047d may be formed so that the rims of the respective end portions are disposed on the same plane. Thus, the border line (see FIG. 7A) exposed to the outside when the first duct formation member 1047c and the second duct formation member 1047d are coupled to each other may be a straight line as viewed from the front side.

If the coupled end portions of the first duct formation member 1047c and the second duct formation member 1047d are formed in a flat shape as described above, a fusing operation may be easily and conveniently performed using a flat heating plate when fusing the first duct formation member 1047c and the second duct formation member 1047d. As a result, the manufacturing easiness and efficiency of the drying device 1040 can be advantageously enhanced.

Since the lower portion of the first duct formation member 1047c is coupled to the tub 1020, the lower portion of the first duct formation member 1047c may have a shape conformal to an external shape of the tub 1020. For example, the lower portion of the first duct formation member 1047c may have a curved surface corresponding to the outer circumferential surface of the tub 1020 having a cylindrical columnar shape. Thus, the first duct formation member 1047c advantageously has a significant contact area with the outer circumferential surface of the tub 1020.

A flow path expanding portion 1047e protruding radially outward to expand a flow path of the air passing through the tub 1020 may be formed in one end portion of the second duct formation member 1047d, namely the end portion of the second duct formation member 1047d on the side of the fan 1041.

A condensing water introduction port 1047a through which condensing water is introduced may be disposed in the hot air discharge duct 1047. A separate connector 1047f may be coupled to the condensing water introduction port 1047a. A nozzle, a hose and the like for supplying the condensing water may be coupled to the connector 1047f.

The condensing water (not shown) supplied into the hot air discharge duct 1047 through the condensing water introduction port 1047a can absorb moisture from the air passing through the hot air discharge duct 1047. As a result, air passing through the hot air discharge duct 1047 is cooled and dehumidified, and then re-introduced back to the fan 1041.

As described above, the drying device 1040 provided in the wall-mounted washing machine 1000 according to one embodiment of the present disclosure offers enhanced drying efficiency as it can efficiently supply air into the tub 1020 through the fan 1041 and efficiently discharge the air from the tub 1020.

At least one curved portion 1047b may be formed on one surface of the hot air discharge duct 1047 opposite to the condensing water introduction port 1047a. The curved portion 1047b may bulge toward the condensing water introduction port 1047a. In the drawings, there is shown only one curved portion 1047b having a convex shape. However, the present disclosure is not limited thereto. A plurality of curved portions 1047b may be used and form a wave shape or the like (see FIG. 10).

The curved portion 1047b on one surface of the hot air discharge duct 1047 can advantageously increase contact area and contact time between the condensing water and air passing through the hot air discharge duct 1047.

In other words, the condensing water supplied to the hot air discharge duct 1047 encounters the curved portion 1047b and then flows toward the lower portion of the hot air discharge duct 1047 along the curved portion 1047b. This increases the area and the time in which the condensing water flows along the inner surface of the hot air discharge duct 1047, whereby the contact area and the contact time of the condensing water with the air in the hot air discharge duct 1047. Consequently, the efficiency of dehumidifying and cooling the air introduced into the fan 1041 is enhanced and the drying efficiency of the drying device 1040 is increased accordingly.

The condensing water introduction port 1047a may be configured such that the area of the longitudinal cross section grows larger from the central portion toward the opposite end portions. For example, the condensing water introduction port 1047a may be configured such that the length L2 of the end portion becomes larger than the length L1 of the central portion (see FIG. 14). In addition, the condensing water introduction port 1047a may have a polygonal shape with the respective sides of the transverse cross section protruding inward. For example, the transverse cross section of the condensing water introduction port 1047a may have a rhombic shape in general with the respective sides of a rectangle protruding inward. As used herein, the term “longitudinal” may refer to the Y-axis direction on the basis of FIG. 3, namely the left-right direction when the wall-mounted washing machine 1000 is viewed from the front side, and the term “transverse” may refer to the X-axis direction on the basis of FIG. 3, namely the front-rear direction when the wall-mounted washing machine 1000 is viewed from the front side.

With the configuration of the condensing water introduction port 1047a as described above, the surface area of the injected condensing water advantageously increases. This can increase the contact area of the condensing water with the air flowing through the hot air discharge duct 1047.

An exemplary method of drying objects loaded in the washing machine performed by the drying device 1040 is described as follows. When a drying operating is started, e.g., by a user, the fan 1041 is activated. As air moves along the hot air supply duct 1043 by the operation of the fan 1041, the air is heated to a high temperature by the drying heater 1045, whereby hot air is generated. The hot air is sequentially introduced into the tub 1020 and the drum 1030 through the tub front panel 1025. The hot air dries the washing objects by making contact with the washing objects inside the drum 1030. Thereafter, the hot air used for drying the washing objects is introduced into the hot air discharge duct 1047 through a hot air discharge port 1024 formed in the rear lower portion of the tub 1020. As described above, the hot air is then dehumidified by the condensing water and is re-introduced into the fan 1041. Such a process may be repeatedly performed to carry out the drying work.

To enhance the drying efficiency of the drying device 1040, one end portion of the hot air supply duct 1043 may be coupled to the fan 1041. The other end portion of the hot air supply duct 1043, namely the end portion of the hot air supply duct 1043 on the side of the tub front panel 1025, to which the hot air is supplied, may be coupled to the front upper portion of the tub front panel 1025. In this case, the hot air supply duct 1043 may include a portion extending along the upper surface of the tub 1020 and a portion bent from the extended end portion toward the front surface of the tub 1020 (extending downward). Thus, the other end portion of the hot air supply duct 1043 may be coupled to the front surface of the tub front panel 1025.

Furthermore, one end portion of the hot air discharge duct 1047 may be coupled to the fan 1041. The other end portion of the hot air discharge duct 1047, namely the end portion of the hot air discharge duct 1047 on the side of the tub 1020, through which the hot air is introduced from the tub 1020 into the drying device 1040, may be coupled to the lower rear side of the side surface of the tub 1020. In other words, the other end portion of the hot air supply duct 1043 may be biased frontward on the basis of a centerline Cl shown in FIG. 9 and may be coupled to the tub front panel 1025 above a centerline C2 shown in FIG. 8. The other end portion of the hot air discharge duct 1047 may be biased rearward on the side surface of the tub 1020 on the basis of the centerline Cl shown in FIG. 9 and may be coupled to the tub 1020 below the centerline C2 shown in FIG. 8.

By coupling the hot air supply duct 1043 and the hot air discharge duct 1047 to the front upper portion of the tub 1020 and the lower rear side of the side surface of the tub 1020 as described above, hot air is introduced from the hot air supply duct 1043 toward the front side of the tub 1020. After drying the washing objects accommodated in the drum 1030, the hot air is discharged through the hot air discharge duct 1047 on the rear side of the tub 1020. Thus, hot air supplied to the tub 1020 through the drying device 1040 can be circulated through the interior of the drum 1030 as a whole. Consequently, the drying efficiency of the washing objects can be enhanced. A water level detecting sensor 1070 may be coupled to the tub front panel 1025. The water level detecting sensor 1070 may be, for example, a pressure sensor. The water level detecting sensor 1070 may be coupled to a separate pipe branched from the water drain device 1023 of the tub 1020 and can measure the internal pressure of the tub 1020. The water level detecting sensor 1070 may measure the amount of the washing water stored in the tub 1020 by sensing the internal water pressure of the tub 1020.

As one example, the water level detecting sensor 1070 may be disposed in the front upper portion of the tub front panel 1025. In this case, the water level detecting sensor 1070 may be disposed more frontward than the drying device 1040 disposed above the tub 1020. More specifically, the fan 1041 in the drying device 1040 may be disposed more rearward than the water level detecting sensor 1070.

The water level detecting sensor 1070 can be sensitive to heat as it has electronic parts. In other words, when heat is applied to the water level detecting sensor 1070, the water level detecting sensor 1070 may fail to operate properly or may even be damaged. Accordingly, it is important to set the positional relationship between the water level detecting sensor 1070 and the drying device 1040 including the drying heater 1045 as it produces heat.

In the wall-mounted washing machine 1000 according to one embodiment of the present disclosure, the water level detecting sensor 1070 may be disposed more adjacent to the fan 1041 than the hot air supply duct 1043 of the drying device 1040. In other words, the distance between the water level detecting sensor 1070 and the fan 1041 may be shorter than the distance between the water level detecting sensor 1070 and the hot air supply duct 1043. In this regard, the distance between two members refers to the minimum distance between the two members. When viewed as a whole, the water level detecting sensor 1070 may be biased toward the hot air discharge duct 1047 of the drying device 1040 on the basis of the drying device 1040.

During the operation of the drying device 1040, air passing through the fan 1041 of the drying device 1040 moves along the hot air supply duct 1043 and is heated by the drying heater 1045. Thereafter, air passing through the tub 1020 and the drum 1030 is cooled and dehumidified by the condensing water while moving along the hot air discharge duct 1047. Thus, the temperature of the air when it is just introduced into the fan 1041 may be the lowest in the entire air circulation lines of the drying device 1040. As a result, in the wall-mounted washing machine 1000 according to one embodiment of the present disclosure, overheating of the water level detecting sensor 1070 may be prevented by positioning the water level detecting sensor 1070 adjacent to the fan 1041.

The housing 1060 may be coupled to the rear panel 1010. The housing 1060 is a member coupled to the rear panel 1010 and forms an outer shell of the wall-mounted washing machine 1000. The housing 1060 may include a side cover 1061 open on the front and rear sides thereof and coupled to the rim of the rear panel 1010 on the rear side thereof, a front cover 1062 coupled to the open front side of the side cover 1061 and having an opening 1062b, and a door 1063 rotatably coupled to the front cover 1062 and configured to selectively close and open the opening 1062b.

An operation unit 1062a may be disposed in the front cover 1062. The operation unit 1062a is provided to enable a user to control the wall-mounted washing machine 1000. Buttons of the operation unit 1062a may be exposed through the front cover 1062. The operation unit 1062a may be entirely disposed under the detour rib 1027 formed in the tub front panel 1025 described above. Thus, the washing water leaked from the interior of the wall-mounted washing machine 1000 may flow along the detour rib 1027 without entering the operation unit 1062a.

A hinge coupling portion may be formed in the front cover 1062. The hinge coupling portion may be disposed on the front surface of the front cover 1062 and is depressed by a predetermined depth. A door hinge may be coupled to the hinge coupling portion.

The door 1063 is used to open and close the opening 1062b of the front cover 1062. For example, the door 1063 may be coupled to the front cover 1062 via the door hinge. A user may close or open the door 1063 using a handle of the door 1063. Alternatively, the door 1063 may be an electronic door and can be opened or closed in a one touch manner through an operation button in the front cover 1062.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is :

1. A wall-mounted washing machine comprising:
a tub; and
a drying device comprising: a fan coupled to the tub and configured to propel air; a hot air supply duct coupled to the fan and configured to guide air flowing from the fan to the tub; a drying heater disposed inside the hot air supply duct and configured to heat air inside the hot air supply duct; and a hot air discharge duct coupled to the tub and configured to guide air exiting from the tub toward the fan and dry air exiting from the tub,
wherein the hot air discharge duct comprises a first duct formation member disposed on an outer circumferential surface of the tub and a second duct formation member fused to the first duct formation member, and
wherein the first duct formation member and the second duct formation member comprise fused surfaces formed on a same plane.

2. The wall-mounted washing machine of claim 1, wherein the second duct formation member comprises an end portion which comprises a flow path expanding portion protruding radially outward to expand an air flow path for air exiting from the tub.

3. The wall-mounted washing machine of claim 1, wherein the first duct formation member comprises a lower portion and an upper end portion, wherein the lower portion of the first duct formation member has a shape corresponding to an external shape of the tub, and wherein the upper end portion of the first duct formation member is disposed on the same plane as a lower end portion of the second duct formation member.

4. The wall-mounted washing machine of claim 1, wherein a lower portion of the first duct formation member has a curved surface shape.

5. The wall-mounted washing machine of claim 1, wherein the drying device further comprises a condensing water introduction port disposed in the hot air discharge duct, wherein the condensing water introduction port is configured to receive condensing water supplied to the hot air discharge duct, and
wherein at least one curved portion is formed on one surface of the hot air discharge duct opposite to the condensing water introduction port.

6. The wall-mounted washing machine of claim 5, wherein the one surface of the hot air discharge duct bulges toward the condensing water introduction port.

7. The washing machine of claim 5, wherein a longitudinal cross section of the condensing water introduction port has an area that grows larger from a central portion of the condensing water introduction port toward opposite end portions of the condensing water introduction port.

8. The wall-mounted washing machine of claim 1, wherein the fan, the hot air supply duct, the tub and the hot air discharge duct are configured to form a closed air circulation path.

9. The wall-mounted washing machine of claim 5, further comprising:
a rear panel configured to support the tub and to be affixed to a wall surface;
a drum rotatably installed inside the tub and configured to accommodate washing objects; and
a tub front panel coupled to a front surface of the tub.

10. The wall-mounted washing machine of claim 9, wherein the drying device is configured to communicate air with a front upper portion of the tub front panel and a rear lower portion of the tub.

11. The wall-mounted washing machine of claim 9, wherein a first end portion of the hot air supply duct that is proximate to the tub front panel is coupled to the front upper portion of the tub front panel, and wherein a second end portion of the hot air discharge duct that is proximate to the tub is coupled to the rear lower portion of the tub.

12. The wall-mounted washing machine of claim 9, wherein the drying heater is configured to, when the fan is operational, heat air passing through the hot air supply duct, wherein further air exiting from the hot air supply duct is introduced into the tub through the tub front panel, wherein the condensing water is operable to cool and dehumidify air exiting from the tub, and wherein air exiting from the hot air discharge duct is introduced into the fan.

13. The wall-mounted washing machine of claim 9, wherein the rear panel comprises at least one vent hole for air to flow through. 20

14. The wall-mounted washing machine of claim 9, wherein a rear surface of the rear panel comprises a plurality of ribs, and wherein end portions of the plurality of ribs comprise cut away portions that form air circulation grooves.
